(19) United States
(12) Patent Application Publication
(10) Pub. No.: US 2013/0004690 A1
(43) Pub. Date: Jan. 3, 2013

(54) HYDROPHILIC EXPANDED FLUOROPOLYMER COMPOSITE AND METHOD OF MAKING SAME

(76) Inventors: Michael G. Mikhael, Tucson, AZ (US); Anthony J. LaBoy, Newark, DE (US)

(21) Appl. No.: 13/172,081

(22) Filed: Jun. 29, 2011

(51) Int. Cl. B32B 3/26; B32B 27/08; B05D 3/06; D02G 3/36; B05D 5/00; B32B 5/00; B32B 1/08

(52) U.S. Cl. 428/36.5; 428/319.3; 428/219; 428/376; 427/243; 427/509

(57) ABSTRACT

A hydrophilic expanded fluoropolymer membrane having a coating comprising a copolymer comprising a non-wetting monomer and a fluoromonomer is described. In one embodiment, the non-wetting monomer and fluoromonomer are cross linked. A process of vaporizing, condensing and curing a formulation or formulations comprising the non-wetting monomer and/or the fluoromonomer is described. In one embodiment the condensed formulation is exposed to a high energy source such as a UV lamp for example to cross link the non-wetting monomer with the fluoromonomer. The coating may be conformable coating and may provide a hydrophilic membrane that has high water flow rates.

### BACKGROUND OF THE INVENTION

1. Field of the Invention

The invention relates to coated expanded fluoropolymer membranes that are hydrophilic.

2. Background

Expanded fluoropolymer membranes are used in many filtration applications such as air and water filtration. Most expanded fluoropolymer membranes are hydrophobic and require some modification to the surface or pre-wetting for use in liquid and especially water filtration. Solution type coatings of expanded fluoropolymer membranes require the expanded fluoropolymer membrane to be wet with the solution and then dried to leave a sufficient amount of coating or polymer to render the membrane hydrophilic. The polymer coating typically comprises a hydrophilic polymer that does not readily wet the expanded fluoropolymer membrane surface. The surface energy of the hydrophilic polymer is typically much higher than the surface energy of the expanded fluoropolymer membrane, and therefore does not uniformly deposit over the surface. In addition, the hydrophilic polymer coating can bridge or form webbing across the microstructure which can significantly reduce the permeability of the expanded fluoropolymer membrane.

In addition, wetting and drying of the expanded fluoropolymer membrane may cause the membrane to shrink or collapse as the solvent is volatilized from the surface. This shrinkage or collapse of the membrane structure in most cases causes the membrane to become more dense and reduces permeability. This is not desirable, as a high permeability is desired in filtration applications. The collapse or shrinkage of the membrane becomes even more significant when a highly fibrillated expanded fluoropolymer membrane having a high bubble point pressure and small pore size is coated from a solution, as it is more susceptible to collapse. Expanded fluoropolymer membranes having a microstructure comprised substantially of only fibrils, may have as much as a 50% drop in permeability as a result of coating with a solution and drying.

There exists a need for a coated expanded fluoropolymer membrane having a uniform coating and substantially no collapse or shrinkage. There exists a need for a method of coating an expanded fluoropolymer membrane with a uniform hydrophilic coating that does not cause the membrane to collapse or shrink.

### SUMMARY OF THE INVENTION

The invention is directed to articles comprising an expanded fluoropolymer having a coating of at least one non-wetting hydrophilic monomer and at least one fluoromonomer and methods to produce the same. The expanded fluoropolymer membrane may be an expanded polytetrafluoroethylene (ePTFE), membrane, and may comprise a microstructure of substantially only fibrils. The expanded fluoropolymer membrane may comprise a coating of a copolymer having at least one non-wetting monomer, and at least one fluoromonomer. In some embodiments the copolymer coating comprises a non-wetting monomer cross-linked with a fluoromonomer.

The copolymer may comprise a fluoromonomer including but not limited to a fluoroacrylate, perfluoroacrylate, or perfluoroalkyl-2-hydroxypropylmethacrylate. The copolymer may comprise a carboxylic group, or acrylic acid. The non-wetting monomer may comprise a hydrophilic monomer. The non-wetting monomer may have a surface energy of at least 5 dynes/cm greater than the expanded fluoropolymer.

In some embodiments, the expanded fluoropolymer membrane is rendered hydrophilic and in some embodiments the coating is a conformable coating. The specific surface area of the coated expanded fluoropolymer membrane may be 10 m²/g or more. The expanded fluoropolymer membrane may be greater than 20 um thick and may have an effective amount of coating on both a first coated surface and a second non-coated surface, such that both the first and second surfaces are hydrophilic.

The copolymer coating on the expanded fluoropolymer membrane may comprise a hydrophilic monomer that is copolymerized and cross-linked to a fluoroacrylate monomer. In other embodiments the hydrophilic monomer may be cross-linked to a fluoromonomer by a multifunctional acrylate.

The copolymer may be flash evaporated and condensed onto the expanded fluoropolymer membrane and then polymerized to produce a hydrophilic expanded fluoropolymer membrane. A formulation comprising a high energy source, such as but not limited to an ultraviolet light, electron beam, or heat may be used to polymerize or cross-link the copolymer. In some embodiments, the expanded fluoropolymer membrane has a first and second surface that are coated with a formulation or formulations as described herein to render the expanded fluoropolymer membrane hydrophilic. In some embodiments, the copolymer is only coated on a first surface of the expanded fluoropolymer membrane. A formulation or formulations comprising at least one “non-wetting hydrophilic monomer” and/or at least one fluoromonomer may be coated onto one or both sides of the expanded fluoropolymer. A cross-linking monomer may be part of the formulation or formulations. In one embodiment, a formulation comprising at least one “non-wetting hydrophilic monomer” and at least one fluoromonomer, and a cross-linking monomer may be evaporated and condensed onto the surface of an expanded fluoropolymer membrane and subsequently exposed to a high energy source and cross-linked. In another embodiment the fluoromonomer and the non-wetting monomer may be evaporated and condensed separately from two different formulations onto the expanded fluoropolymer membrane. In another embodiment, the article takes the form of a tube, rod, or fiber.

### BRIEF DESCRIPTION OF THE DRAWINGS

FIG. 1A shows a surface scanning electron micrograph (SEM) of the uncoated expanded fluoropolymer membrane described in example 1 along with the results of the x-ray photoelectron spectroscopy (XPS).

FIG. 1B shows a surface scanning electron micrograph (SEM) of the first surface side of the expanded fluoropolymer membrane described in Example 1 along with the results of the x-ray photoelectron spectroscopy (XPS).

FIG. 1C shows a surface scanning electron micrograph (SEM) of the second surface side of the expanded fluoropolymer membrane described in Example 1 along with the results of the x-ray photoelectron spectroscopy (XPS).

FIG. 2A shows a surface scanning electron micrograph (SEM) of the uncoated expanded fluoropolymer membrane described in Example 2 along with the results of the x-ray photoelectron spectroscopy (XPS).

FIG. 2B shows a surface scanning electron micrograph (SEM) of the first surface side of the expanded fluoropolymer membrane described in Example 2 along with the results of the x-ray photoelectron spectroscopy (XPS).

FIG. 2C shows a surface scanning electron micrograph (SEM) of the second surface side of the expanded fluoropolymer membrane described in Example 2 along with the results of the x-ray photoelectron spectroscopy (XPS).

FIG. 3A shows a fluorescent microscope image of a cross-section of the expanded fluoropolymer membrane described in Example 2, where fluorine is indicated by a white.

FIG. 4A shows a side view of a vacuum coating chamber.

FIG. 4B shows a side view of a continuous vacuum coating chamber.

FIG. 5 shows a side view of a batch vacuum coating chamber.

FIG. 6 shows a side view of UV curing conveyor.

FIG. 7 shows a graph of a thermal gravitational analysis (TGA).

FIG. 8 shows a graph of a thermal gravitational analysis (TGA).

Corresponding reference characters indicate corresponding parts throughout the several views of the drawings.

### DETAILED DESCRIPTION OF THE INVENTION

### Description

Expanded fluoropolymer membrane, such as expanded PTFE are inherently hydrophobic and most often require modification to the surface, or pre-wetting with solvent before water will pass through. Expanded fluoropolymer membranes are used for many applications, including but not limited to filtration, garments and apparel, electronic wire and cable, and medical devices including catheters. In some of these applications, such as filtration, it is desirable that the expanded fluoropolymer membrane be hydrophilic and allow for the passage of water or liquid from a first surface to a second surface. Conventional techniques for rendering the expanded fluoropolymer membrane hydrophilic have drawbacks such as reducing the thickness or permeability, or providing non-permanent hydrophilic properties. The coated expanded fluoropolymer described herein however comprises a uniform coating that provides for very little loss in permeability and in some embodiments, permanent hydrophilicity.

The coating as described herein is deposited from a vapor, therein more effectively maintaining thickness and permeability than solution coating. Solution coating of expanded fluoropolymer membrane can cause substantial thickness reduction and permeability reduction.

It was surprisingly discovered that a formulation comprising a fluoromonomer could be coated onto an expanded fluoropolymer membrane to produce a hydrophilic coating. It was found that the fluoromonomer component in the coating formulation provides for more thorough wetting of the expanded fluoropolymer membrane surface and enhances the uniformity and depth of the coating. It was further discovered that without the fluoromonomer and as described herein, the hydrophilic coating does not adsorb on the expanded fluoropolymer membrane as effectively and in some embodiments will not provide a hydrophilic surface on the non-coated side of the expanded fluoropolymer membrane.

In one embodiment, the expanded fluoropolymer membrane may be positioned in a vacuum chamber wherein a vapor comprising a coating formulation is deposited on and/or into the expanded fluoropolymer membrane. The coating may be applied to a first and/or second surface and may be coated in multiple steps, in either a roll to roll process or in a batch process. For example, a single piece of material may be placed in a vacuum chamber and coated on a first side in a first coating step, and then coated on a second side in a second coating step. In some cases, the single piece of material may be repositioned, such as by inverting, between the first and second coating step. The expanded fluoropolymer membrane may be exposed to a high energy source to cross-link the coating between or after coating steps. When the expanded fluoropolymer membrane is coated in multiple coating steps, the coating formulation may be the same in each step, or may comprise different components in two or more of the steps. For example, a first coating formulation may be applied in a first coating step and a second coating formulation may be applied in a second coating step. In addition, the first coating formulation may comprise a fluoromonomer and the second coating formulation may comprise a non-wetting hydrophilic monomer. The expanded fluoropolymer membrane may be exposed to a high energy source after being coated with the formulation in multiple steps.

A roll of expanded fluoropolymer membrane may be coated in a continuous or roll-to-roll process where the expanded fluoropolymer membrane is placed into a vacuum chamber and spooled from a pay-off to a take-up around a drum, for example. The coating formulation may be deposited in a single step or in multiple steps as previously described. A high energy source may be positioned such that the expanded fluoropolymer membrane having formulation condensed thereon may be exposed to the high energy source.

After the expanded fluoropolymer membrane has been coated with the coating formulation, it may be subjected to a high energy source, such as UV and visible light, electron beam or heat, to crosslink the monomers to form a coating. Any suitable high energy source may be used to initiate and crosslink the polymer. Heat may be used as the high energy source, such as through the exposure to convective heat, or infrared (IR) heat. The temperature of exposure may be above 60° C. or above 90° C. or between 60° C. and 90° C. or between 60 and 150° C. Any effective amount of time and temperature may be used to cross-link the copolymer. Care should be taken however not to expose the coated expanded fluoropolymer membrane to a temperature and time that substantially degrades the coating. An ultraviolet (UV) light may be used as the high energy source at approximately about 400 W/inch or any other suitable power and exposure time to provide an effective amount of cross-linking. An electron beam may be used as the high energy source, at approximately about 10 kV by 100 mamps or any other effective voltage and amperage to provide sufficient cross-linking.

In one embodiment, the expanded fluoropolymer membrane comprises porous expanded polytetrafluoroethlyene (PTFE), for instance as generally described in U.S. Pat. No. 3,953,566 to Gore. The expandable fluoropolymer may comprise in one embodiment, PTFE homopolymer. In alternative embodiments, blends of PTFE, expandable modified PTFE and/or expanded copolymers of PTFE may be used. Non-limiting examples of suitable fluoropolymer materials are described in, for example, U.S. Pat. No. 5,708,044, to Branca, U.S. Pat. No. 6,541,589, to Baillie, U.S. Pat. No. 7,531,611, to Sabol et al., U.S. patent application Ser. No. 11/906,877, to Ford, and U.S. patent application Ser. No. 12/410,050, to Xu et al. In one embodiment, the expanded fluoropolymer comprises expanded PTFE and in another embodiment, the expanded fluoropolymer consists essentially of PTFE. The expanded fluoropolymer membrane as described herein may comprise any suitable microstructure for achieving the desired combination of properties required for the application. In one embodiment, the expanded fluoropolymer may comprise a microstructure of nodes interconnected by fibrils such as described in U.S. Pat. No. 3,953,566 to Gore. In another embodiment, the expanded fluoropolymer may comprise a microstructure of substantially only fibrils. The expanded fluoropolymer may be in the form of a membrane or sheet and may be comprised of two or more layers of expanded fluoropolymer membrane. The layers of expanded fluoropolymer membrane may have different microstructures.

The coating formulation may comprise a fluoromonomer wherein the monomer comprises at least one fluorine, such as but not limited to a fluoroacrylate, or perfluoroacrylate, a perfluoroalkyl-2-hydroxypropylmethacrylate. The non wetting monomer may comprise a hydrophilic monomer, and may comprise a monomer that has a surface energy at least 5 dynes/cm higher than the expanded fluoropolymer membrane surface energy. Examples of non wetting monomers include but are not limited to, acrylic acid, 2-carboxythyl acrylate, methoxy polyethylene glycol acrylate, and caprolactone acrylate. Other non-wetting monomers include hydroxyl group (i.e. allyl alcohol and 2-hydroxyethyl acrylate); amino group (i.e. allyl amine, 2-(N,N-dimethylamino) ethyl acrylate, and amino styrene); phosphonic group (i.e. vinyl phosphonic acid); and sulfonic monomers (i.e. vinyl sulfonic acid). The surface energy of these monomers are provided in Table 5. In one embodiment the expanded fluoropolymer membrane is expanded PTFE having a surface energy of about 17 dynes/cm and the non-wetting monomer has a surface tension of at least about 5 or more, about 10 or more, or about 20 or more. A non-wetting monomer having a surface energy greater than about 5 or more dynes/cm higher than the expanded fluoropolymer in most cases may not readily wet the surface of the expanded fluoropolymer membrane.

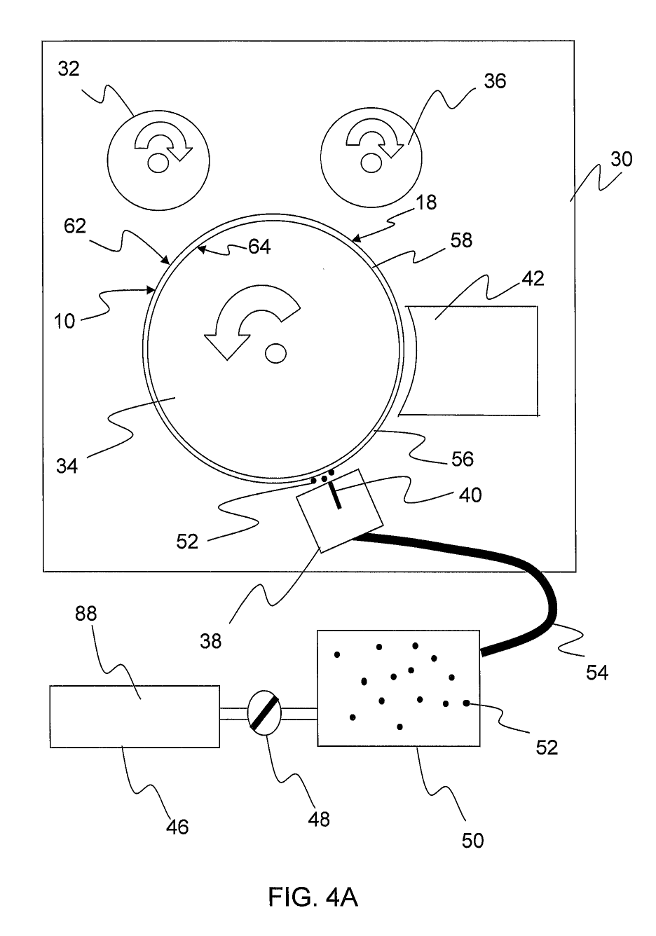

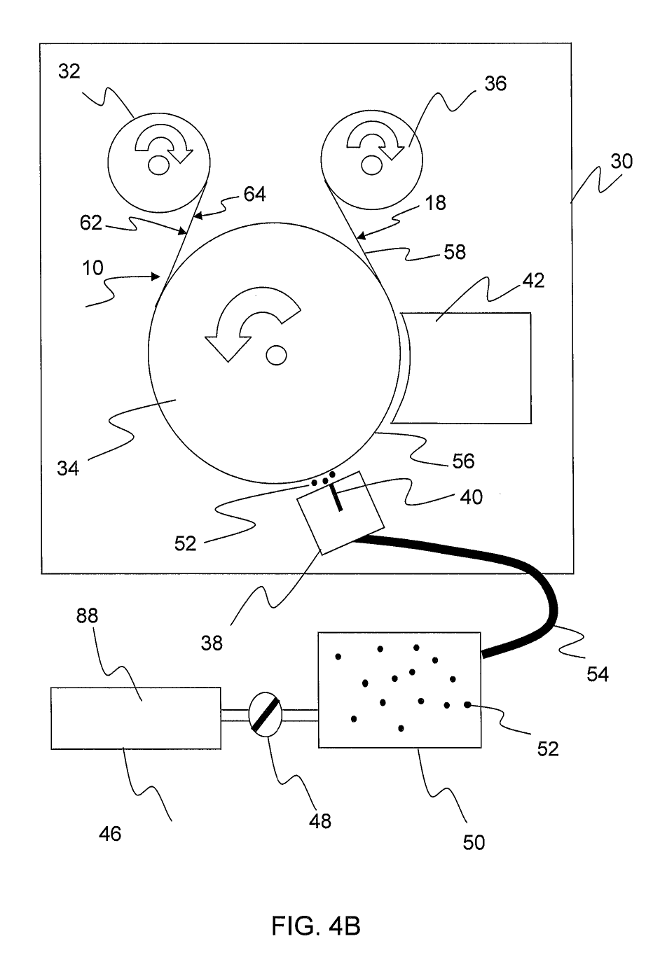

A method of coating an expanded fluoropolymer membrane comprises the steps of placing a roll of expanded fluoropolymer membrane 10 in a vacuum chamber 30 as shown in FIG. 4B around a drum 34. The drum may then be rotated such that the membrane is exposed to a formulation vapor 52 and a UV light source 42. The formulation vapor 52 condenses on the expanded fluoropolymer membrane 10 to provide a condensed formulation 56 on the expanded fluoropolymer membrane 10. The expanded fluoropolymer membrane 10 having the condensed formulation 56 is then subjected to the UV light 42 that causes at least some of the formulation polymer to cross link. The expanded fluoropolymer membrane 10 having the cross linked polymer coating 58 is then taken up around the take-up roll 36. It has been envisioned that an expanded fluoropolymer membrane may be exposed to more than one formulation vapor around the perimeter of the drum. A first formulation vapor may be exposed to the expanded fluoropolymer membrane at one location around the drum and a second formulation vapor may be exposed to the expanded fluoropolymer membrane at a second location around the drum. The first and second formulation may be the same or comprise different components, as previously described herein. In addition, one or more high energy sources, such as a UV light, for example, may be positioned around the drum. In one embodiment one or more high energy sources may be positioned between two or more vapor depositions.

The formulation vapor 52 as shown in FIG. 4B is formed when the formulation 88 is pumped from a syringe pump 46 into an evaporator 50 and then through a conduit 54 into the vacuum chamber 30. The evaporator is a large heated volume of space wherein the formulation turns into a vapor. In some embodiments, the conduit is heated to a temperature to keep the formulation in a vapor and sufficiently eliminate condensation of the vapor. The formulation vapor may then be pulled by vacuum from the evaporator 50 to the nozzle 38, and out of the nozzle opening 40, where it may condense onto an expanded fluoropolymer membrane.

As shown in FIG. 4B the expanded fluoropolymer membrane is supported by a drum, however any number of different membrane supports and coating configurations have been envisioned, including but not limited to a belt, or porous belt, or the like. In addition, the expanded fluoropolymer membrane may be unsupported over a region whereby the formulation is condensed, such as between rolls. In one embodiment, an additional layer or layers of material such as a porous material may be on the surface of the membrane support, and it may aid in the distribution of the coating.

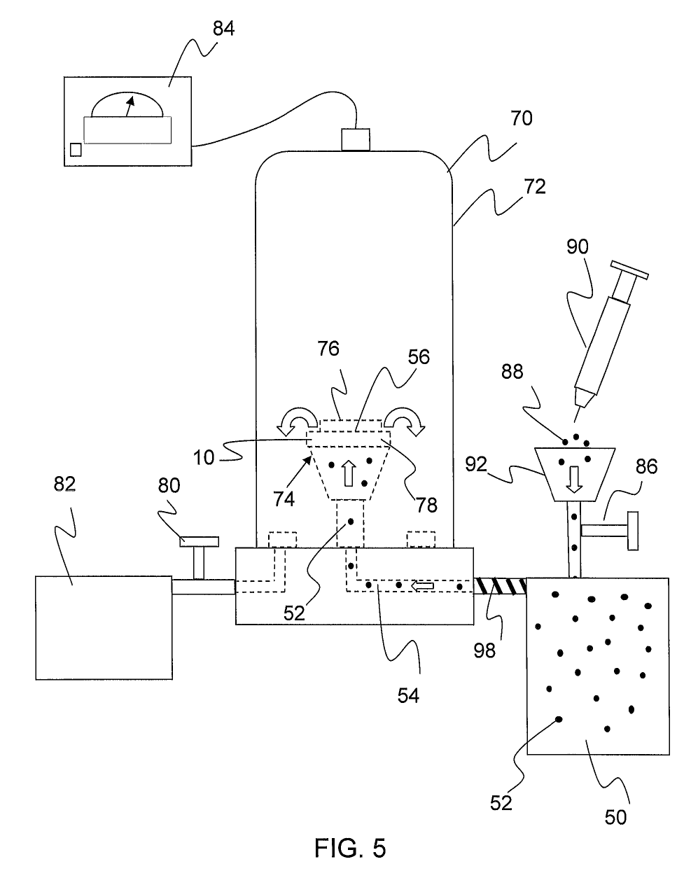

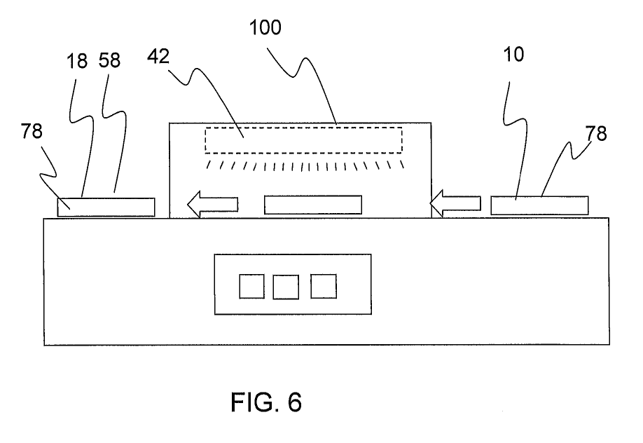

Another method of coating an expanded fluoropolymer membrane comprises the steps of placing a piece of expanded fluoropolymer membrane 10 in a vacuum chamber 70 as shown in FIG. 5. The piece of expanded fluoropolymer membrane 10 may be placed in a support hoop 78 and placed on the coating stage 74 where the coating formulation vapor 52 contacts the expanded fluoropolymer membrane. A mask 76 may be placed on the side opposite the incident formulation vapor 52. Vapor and air can move through the expanded fluoropolymer membrane between the outer perimeter of the mask 76 and the support hoop 78 boundary as indicated by the arrows in FIG. 5. The formulation 88 may be injected into a port, 92 where it passes into an evaporator 50, then through a conduit 54 and into the coating stage 74. After the expanded fluoropolymer membrane has been coated, it may be removed from the vacuum chamber and subjected to a high energy source to cross link the polymer. As shown in FIG. 6 the expanded fluoropolymer membrane 10 in the support hoop 78 may be placed on a UV curing conveyor 100 and passed by a UV light source 42. Again, any number of different coating methods and iterations have been envisioned. In one embodiment, the expanded fluoropolymer membrane may be coated with a first coating formulation of a first side, and then inverted on the coating stage and coated with a second coating formulation. The expanded fluoropolymer membrane may be subjected to high energy sources between coating steps.

The coated expanded fluoropolymer membrane may comprise a support material attached to at least one surface. The support material may include but is not limited to a woven or non-woven material, felt, fabric, or another expanded fluoropolymer, and the like. The coated expanded fluoropolymer membrane may also comprise at least a portion of a tube, fiber, rod, or the like.

### Test Methods

### Specific Surface Area

Specific surface area is a property of a material and is used to characterize the physical surface area per gram of material. In particular, it is used to characterize porous materials. As used in this application, the specific surface area, expressed in units of m²/g, was measured using the Brunauer-Emmett-Teller (BET) method on a Coulter SA3100Gas Adsorption Analyzer (Beckman Coulter Inc. Fullerton Calif.). To perform the measurement, a sample was cut from the center of the expanded fluoropolymer membrane and placed into a small sample tube. The mass of the sample was approximately 0.1 to 0.2 gm. The tube was placed into the Coulter SA-Prep Surface Area Outgasser (Model SA-Prep, P/n 5102014) from Beckman Coulter, Fullerton Calif., and purged at 110° C. for two hours with helium. The sample tube was then removed from the SA-Prep Outgasser and weighed. The sample tube was then placed ino the SA3100 Gas adsorption Analyzer and the BET surface area analysis was run in accordance with the instrument instructions using helium to calculate the free space and nitrogen as the adsorbate gas.

### Pore Size—Bubble Point Measurement

Bubble point is a relative measure of the largest pore size in a porous material. The higher the bubble point pressure the smaller the size of the largest pore. A porous material is wet with a wetting liquid and gas pressure on one side of the sample is increase while the flow through the sample is measure. The lowest pressure required to remove the liquid from a pore is referred to as the bubble point. Bubble point and mean flow pore size were measured according to the general teachings of ASTM F31 6-03 using a capillary flow Porometer (Model CFP 1500AEXL from Porous Materials, Inc., Ithaca N.Y.). The sample membrane was placed into the sample chamber and wet with SilWick Silicone Fluid (available from Porous Materials Inc.) having a surface tension of approximately 20 dynes/cm. The bottom clamp of the sample chamber had a 2.54 cm diameter hole. Using the Capwin software, the following parameters were set as specified in table 1 below.

TABLE 1

| Parameter | set point |
|---|---|
| Maxflow (cc/m) | 200000 |
| Bublflow(cc/m) | 100 |
| F/PT (old bubltime) | 50 |
| Minbpress (PSI) | 0 |
| Zerotime (sec) | 1 |
| V2incr(cts) | 10 |
| Preginc (cts) | 1 |
| Pulse delay(sec) | 2 |
| Maxpre (PSI) | 500 |
| Pulse width (sec) | 0.2 |
| Mineqtime (sec) | 30 |
| Presslew (cts) | 10 |
| Flowslew (cts) | 50 |
| Eqiter | 3 |
| Aveiter | 20 |
| Maxpdif (PSI) | 0.1 |
| Maxfdif (PSI) | 50 |
| Sartp(PSI) | 1 |
| Sartf (cc/m) | 500 |

### Permeability—Gurely Desometer

The air permeability of some samples was measured using a Gurley Densometer. The Gurley air flow test measures the time in seconds for 100 cm³ of air to flow through a 6.45 cm² sample at 12.4 cm of water pressure. The samples were measured using a Gurley Densometer Model 4340 Automatic Densometer.

### Permeability—Frazier

The air permeability of some samples was measured by a frazier test. A frazier number is a measure of the flow rate through a sample in feet per minute at a pressure drop across the sample of 0.5 inches of water or approximately 125 Pa. A Textest FX3310 Air Permeability Test available from Textest Instruments, Schwerzenbach, Switzerland was used for the frazier testing. The test pressure was set to 125 Pa.

### Specific Resistance

The specific resistance of samples was calculated from the permeability measured where:

Specific resistance(krayls)=gurley(sec)×7.8344,or

Specific resistance(krayls)=24.4921/Frazier(fpm)

### Specific Mass

Specific mass is the mass of a material normalized by the area of the material. Specific mass is measure and calculated by cutting and measuring the area of the sample, such as by measuring the cut length and cut width, and then weighing the cut sample. The mass measured is then divided by the calculated area to determine specific mass and is reported as gram per square meter, g/m̂2.

### Hydrophilic

A sample of membrane was subjected to water on one surface to determine hydrophilicity. A drop or drops of water were place on one surface of the membrane and the second or opposite surface was evaluated after approximately 10 seconds to determine if water was penetrating through the sample. A water absorbent material such as a paper towel was in some cases used to determine water penetration through the sample. The paper towel was contacted to the second surface and then removed for evaluation. If the paper towel was wet, then the sample was determined to be hydrophilic.

### Water Flow Time

The following procedure was used to measure the water flow time through the membrane. The membrane was either draped across the tester (Sterifil Holder 47 mm Catalog Number: XX11J4750, Millipore) or cut to size and laid over the test plate. The tester was filled with de-ionized water. A pressure of 33.87 kPa was applied across the membrane; the time for 400 ml of de-ionized water to flow through the membrane was measured.

Second water flow time is the time to flow 400 ml of deionized water after the sample has been wet with water and dried.

Water flow time is inversely related to water flow rate.

### Coating Weight

Coating weight was determined through thermogravimetric analysis (TGA) using a Q5000IR TGA available from TA Instruments (159 Lukens Drive New Castle, Del. 19720 USA). Approximately 5 mg of coated expanded fluoropolymer membrane was cut and placed into a high temperature TGA pan and loaded into the instrument. The sample weight was then monitored as the pan was heated from ambient to 1000° C. using a linear heating rate of 20° C./minute with an air purge of 25 ml/minute. Analysis was subsequently carried out by measuring the percent weight loss which occurs during the degradation of the coating. This process is facilitated through the use of a first derivative curve of the weight versus temperature plot (weight loss events are defined as occurring between minima in the derivative curve).

Surface Analysis using X-ray Photoelectron Spectroscopy (XPS)

X-ray Photoelectron Spectroscopy (XPS) is the most widely used surface characterization technique providing non-destructive chemical analysis of solid materials. Samples are irradiated with mono-energetic X-rays causing photoelectrons to be emitted from the top 1-10 nm of the sample surface. An electron energy analyzer determines the binding energy of the photoelectrons. Qualitative and quantitative analysis is available on all elements except hydrogen and helium at detection limits of ˜0.1-0.2 atomic percent. Chemical state and bonding information is obtained using high resolution analysis. Specifically, this work was carried out using a Physical Electronics Quantera Scanning X-ray Microprobe using a monochromatic Al Kₐₗₚₕₐ X-ray beam. The work function of the spectrometer was calibrated using the silver 3d_{5/2} binding energy of 368.21 eV from clean silver foil, and the retard linearity was calibrated using the peak separation of 848.66 eV between the copper 2p_{3/2} and gold 4f_{7/2} peaks. Charge compensation was provided using a combination of low energy argon ions and low energy electrons. Survey scans were used to quantify the surface composition from multiple analysis spots to generate an average and standard deviation. High resolution scans were obtained from the carbon, oxygen, and fluorine regions to provide chemical bonding information. All high resolution spectra were referenced to a binding energy of 292.4 eV for polytetrafluoroethylene.

### Fluorescence Microscopy

Fluorescence microscopy was performed using a Zeiss LSM 510 microscope, with a C-Apochromat 40×, 1.2NA water corrected lens and 543 nm and 488 nm lasers. Rhodamine B dye was used as a tracer for the coating. A Nunc chamber slide was used to hold the samples during imaging.

Both surfaces of the each sample were analyzed from small sections of the sample mounted in the Nunc chamber slide. A glass block was placed on the samples. The samples between the Nunc chamber slide and the glass block were wet with a water/dye solution (0.5 g/ml). The cross-section was prepared by sectioning with a straight-razor. The sectioned sample was mounting to a glass block with the sectioned edge oriented along one edge of the glass block. The glass block was oriented perpendicular to the Nunc chamber slide with the sectioned edge facing down so that the sectioned edge could be imaged. This was repeated for each sample.

In the collected images the fluorescence image (red) shows the location of the coating in the sample while the reflection image (green) shows the areas that are not coated. A composite of these two images in shown in the examples.

### Scanning Electron Microscopy

Scanning electron microscopy was performed using a Hitachi SU-8000 FESEM. Small sections of the film samples were mounted to an aluminum stub with a conductive adhesive. Prior to imaging a conductive coating of platinum was applied to the mounted sample with an Emitech K550X sputter coater.

### DEFINITIONS

Formulation as used herein may comprise one or more of the copolymer monomers and/or a cross linker.

Conformable as used herein with reference to the coating on the expanded fluoropolymer membrane means that the coating covers the nodal and fibril surface of the expanded fluoropolymer membrane to render it hydrophilic.

### Example 1

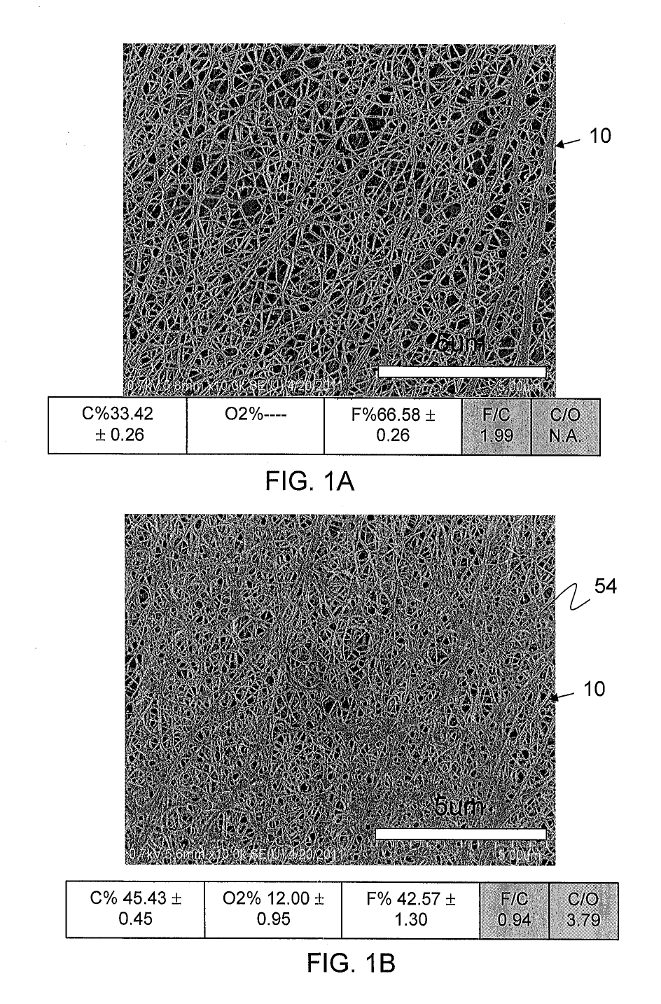

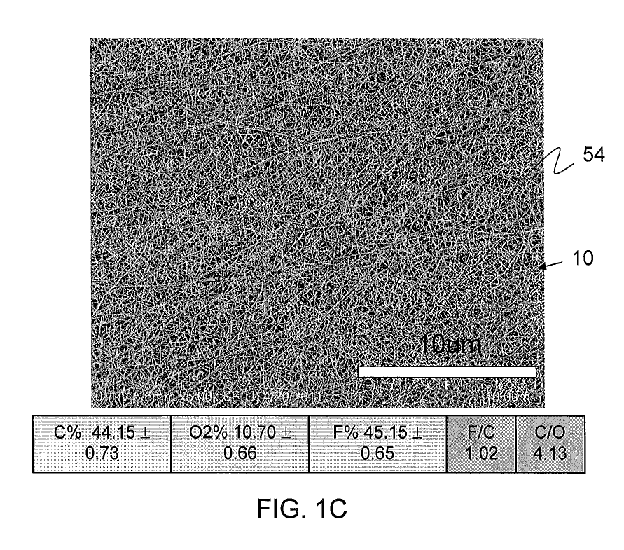

An expanded fluoropolymer membrane generally made following the teaching of U.S. Pat. No. 7,306,729B2, to Bacino et al, shown in FIG. 1A and described in Table 1 as membrane A was coated with a copolymer as described herein to render the expanded fluoropolymer membrane hydrophilic. The expanded fluoropolymer membrane shown in FIG. 1A had a microstructure of substantially only fibrils and will herein be referred to as membrane A.

TABLE 1

| | | | | | Mean | | Bubble | |
|---|---|---|---|---|---|---|---|---|
| | | | Specific | Mean Flow | Flow | | Point | |
| | | Specific | Surface | Pore | Pore | Bubble | Pore | Gurley |
| | Thickness | Mass | Area | Pressure | Diam. | Point | Diam | Time |
| Membrane | um | g/m\hat{ }2 | m\hat{ }2/g | kPa | um | kPa | um | seconds |
| A | 3.91 | 2.0 | 26.51 | 1146 | 0.064 | 518 | 0.1421 | 10.8 |
| Example 1 | 4.57 | | 18.81 | 899 | 0.082 | 517 | 0.1425 | 11.7 |

A piece of membrane A was wrapped around and tape to the drum 34 in the vacuum chamber 30 as shown in FIG. 4A. Membrane A was oriented with a first surface 62 facing away from the drum 34 and a second surface 64 facing the drum, as shown in FIG. 4A. The vacuum chamber was a CHA Mark 50 available from CHA Industries, Fremont, Calif., adapted with a nozzle 38 and a UV light source 42. The door to the vacuum chamber was closed and the chamber was pumped down to 20 torr pressure. The syringe pump was loaded with a formulation. The formulation was prepared by combining 18 weight percent 3-perfluorohexyl-2-hydroxypropyl acrylate wetting monomer, 80 weight percent acrylic acid non-wetting monomer, and two weight percent ethyleneglycol diacrylate cross-linker. Additionally, 2-hydroxy-2-methylpropiophenone free-radical photoinitiator was added to the monomer formulation in an amount equal to approximately 2 weight percent of the total monomer weight. The syringe pump 46 was turned on and the syringe pump valve 48 was opened. The formulation then passed at the rate of 5 ml/min into the preheated (approx. 204° C.) evaporator 50 where the formulation and the free-radical photoinitiator vaporized. The vapor 52 then passed through the heated (204° C.) conduit 54, into the vacuum chamber 30 and into the heated (approx. 150° C.) nozzle 38. The vapor 52 was then drawn out of the nozzle 38 through the 2 mm wide slit opening 40, and onto the expanded fluoropolymer membrane 10. The drum was rotated one revolution at a rate of 13 meter per minute. As membrane A 10 with the condensed formulation 56 passed around the drum 34 it was subjected to the UV light source 42, having a low pressure Hg lamp, B01-356A26U-1V, available from UV-Doctors Company, Baltimore, Md. The UV light source 42 was set to a power level of 10 mA. The UV light source cured and crosslinked the condensed formulation.

The expanded fluoropolymer membrane having a crosslinked copolymer 58 coating was then flipped over and secured around the drum, such that the first surface 62 was now facing the drum 34. The coating process was then repeated, condensing and curing the a same formulation to the second surface of membrane A.

This process produced a coated expanded fluoropolymer membrane 18 having a non-wetting monomer cross-linked with a fluoromonomer as shown in FIG. 1B (first surface) and FIG. 1C (second surface). The coated expanded fluoropolymer membrane made according to this example was tested according to the test method described herein and the results are reported in Table 1 above. The coated membrane made according to this example had a water flow time of 424 seconds whereas the membrane A, or the uncoated membrane did not flow water.

The surface SEM images, FIG. 1B and FIG. 1C show the conformable coating around the microstructure of the expanded fluoropolymer membrane. As shown, very little surface area is blocked by the addition of the copolymer to the expanded fluoropolymer membrane and the permeability was only slightly reduced as the gurley time was increased to 11.7 from 10.8 seconds. In addition, the specific surface area remained high at over 15 m²/g. The bubble point and pressure and pore diameter were not significantly changed. The water flow rate of membrane A after coating was 424 ml/min. Coated membrane A was hydrophilic according to the test method described herein.

The XPS analysis results of membrane A as well as the coated membrane made according to this example are provided under each SEM image in FIG. 1A, FIG. 1B and FIG. 1C. The concentration of the fluorine was reduced from approximately 66.6% to 42.6% on the first side and 45% on the second side of the coated membrane. This reduction of the fluorine concentration and increase in both carbon and oxygen are indicate that the coating comprising acrylic acid is on the surface of the membrane. A summary of the XPS data is provided in Table 2.

TABLE 2

| | Carbon | Oxygen | Fluorine |
|---|---|---|---|
| | % | % | % |
| Membrane A | 33.42 | — | 66.58 |
| Example 1 First Side | 45.53 | 12.00 | 42.57 |
| Example 1 Second Side | 44.15 | 10.70 | 45.15 |

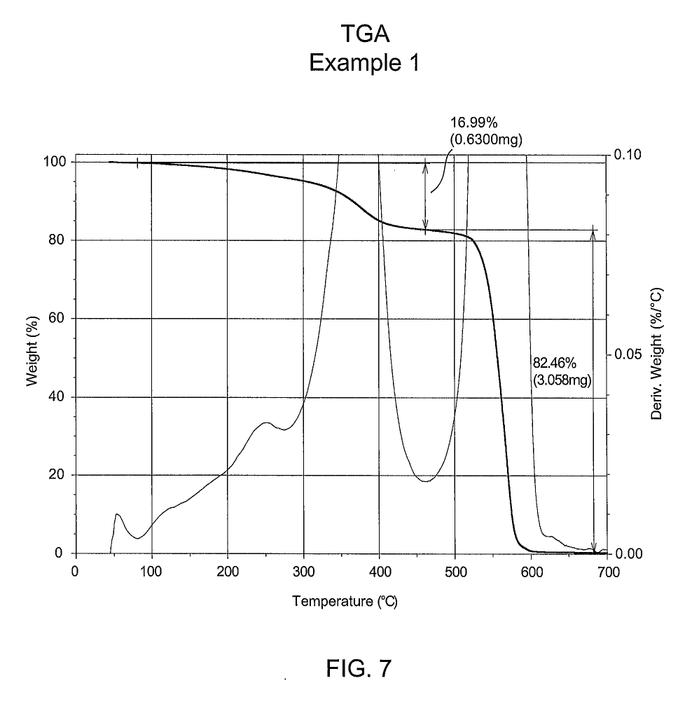

The mass of the coating on membrane A was approximately 17% according to the TGA method. The mass traces from the TGA analysis are provided in FIG. 7.

### Example 2

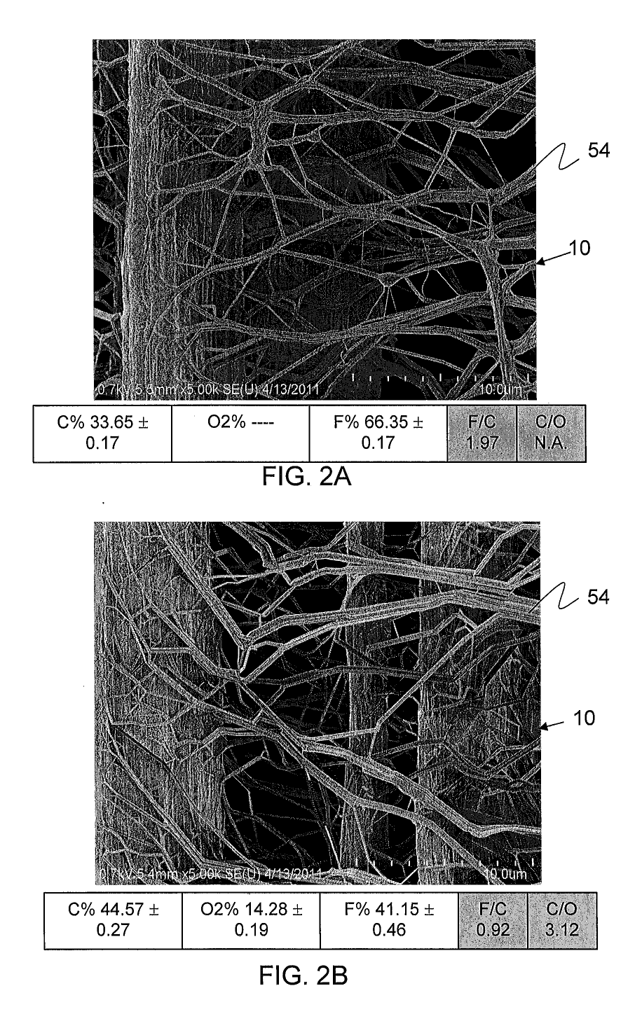

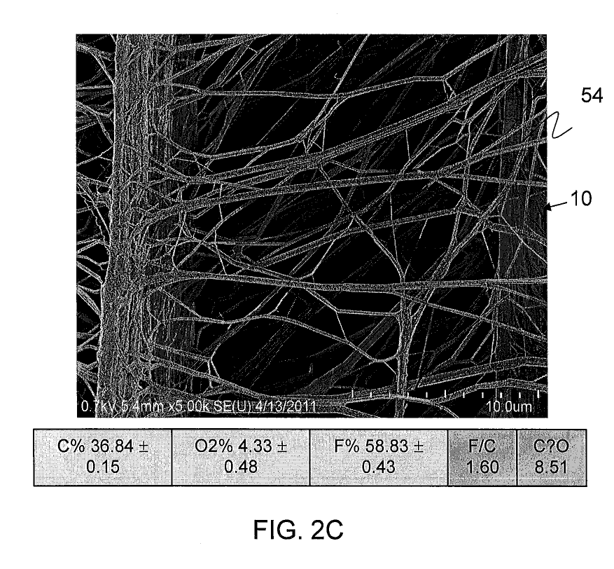

An expanded fluoropolymer membrane made generally following the teaching of U.S. Pat. No. 5,814,405, to Branca et al., shown in FIG. 2A and described in Table 4 as membrane B, was coated with a copolymer as described herein to render the expanded fluoropolymer membrane hydrophilic. Membrane B was coated according to the method described in Example 1, and had the properties described in Table 4. This process produced a copolymer coated expanded fluoropolymer membrane that was hydrophilic according to the test method described herein. As indicated by FIG. 2A, membrane B had a much larger pore size than membrane A shown in FIG. 1A.

As provided in Table 4, the water flow time of membrane B was 840 seconds, whereas the water flow time of the coated membrane made according to Example 2 was only 21.4 seconds. This was a dramatic drop in flow time, indicating a uniform hydrophilic coating through the microstructure of the expanded fluoropolymer membrane.

### Example 3

Membrane B was coated following the method described in Example 1, except that only the first surface was coated. FIG. 2B and FIG. 2C show the first and second surface of the coated membrane of Example 2. Furthermore, FIG. 2B and FIG. 2C show that the coating was uniformly applied to the microstructure resulting in a conformable coating and very little webbing, bridging or agglomeration of the coating. The water flow time of this membrane was 43.3 seconds and the second flow time was 51.1 as provided in Table 4.

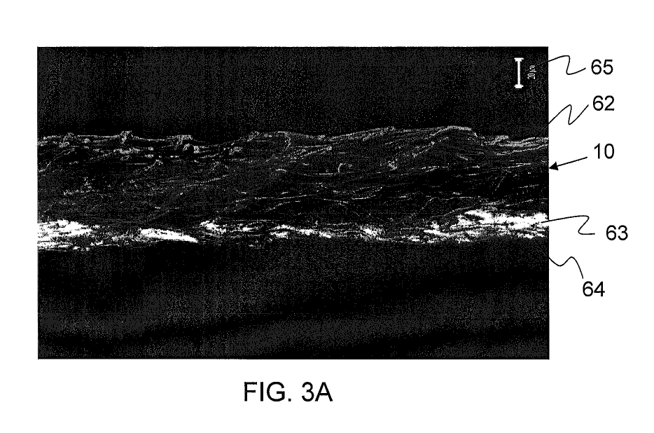

FIG. 3A shows a fluorescence microscopy image of a cross section of the coated membrane of Example 3. The white areas 63 along the bottom of the cross section, or second surface 64 indicate fluorine. The coating almost penetrated completely through this relatively thick sample. A 20 um scale bar 65 is provided on the image, showing that the coated expanded fluoropolymer membrane was approximately 80 um thick. The membrane of Example 3 was hydrophilic according to the test method described herein.

The XPS analysis results of membrane B as well as the coated membrane made according to this Example are provided under each SEM image in FIG. 2A, FIG. 2B and FIG. 2C. The concentration of the fluorine was reduced from approximately 66.4% to 41.5% on the first side and 58.8% on the second side of the coated membrane. This reduction of the fluorine concentration and increase in both carbon and oxygen are indicate that the coating comprising acrylic acid is on the surface of the membrane. A summary of the XPS data is provided in Table 3.

TABLE 3

| | Carbon | Oxygen | Fluorine |
|---|---|---|---|
| | % | % | % |
| Membrane B | 33.65 | — | 66.35 |
| Example 2 First Side | 44.57 | 14.28 | 41.5 |
| Example 2 Second Side | 36.84 | 4.33 | 58.83 |

### Example 4

Membrane B was coated using the CHA Mark 50 vacuum chamber. A roll of membrane B was place on the pay-off 32 and threaded around the drum 34 to the take-up 36. The formulation and coating method described in Example 1 was followed. After the first surface 62 was coated, the take-up roll was moved to the pay-off and the material was thread so that the second surface was now away from the drum. Again, the formulation and coating method described in Example 1 was followed. This continuous process provided a coated expanded fluoropolymer membrane that was hydrophilic according to the test methods described herein. The water flow time and second water flow time of the membrane of Example 4 was 48.4 and 46.9 seconds respectively.

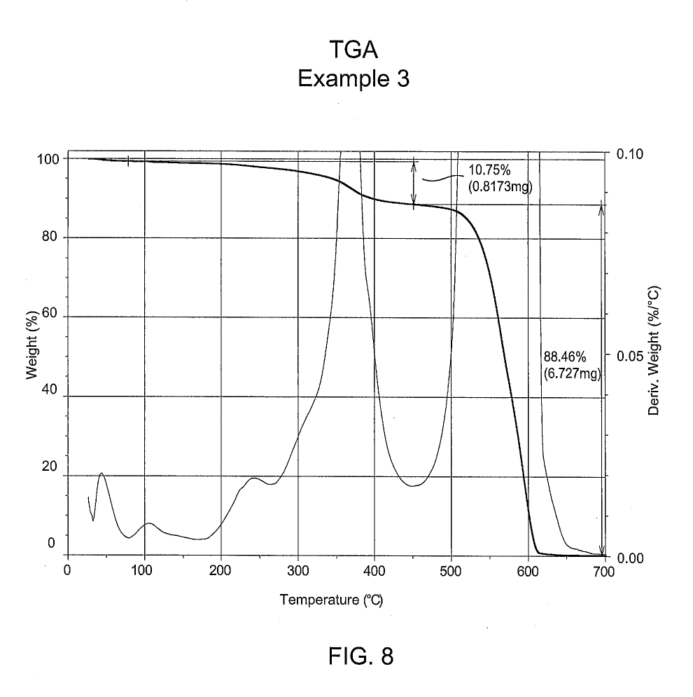

The Frazier number of membrane B was 7.2 and the Frazier number of the coated expanded fluoropolymer membrane of Example 4 was 7.1. The air permeability was not increased which suggest that the coating was conformal and did not block a significant area of the membrane. The mass of the coating according to the TGA analysis provided in FIG. 8 was approximately 10.75%. Again, this mass percentage of the coating coupled with the minimum permeability or specific resistance change, is indicative of a conformal coating.

### Example 5

Membrane B was coated with a copolymer to render it hydrophilic. A sample of expanded fluoropolymer membrane B 10 was supported in a 70 mm diameter hoop 78 and placed in the coating stage 74 within the vacuum chamber 70, as shown in FIG. 5. The vacuum chamber 70 consisted of a modified liquid filtration canister model HFBE3J1A41, available from PALL Corp. Port Washington, N.Y. An approximately 70 mm diameter metal disk was placed on top of the expanded fluoropolymer membrane to act as a mask 76. The vacuum chamber 70 was closed and the vacuum pump 82 was started and the vacuum valve 80 was opened. The syringe 90 was loaded with 0.4 ml of a formulation 88. The formulation was made by combining 18 weight percent 3-perfluorohexyl-2-hydroxypropyl acrylate wetting monomer, 80 weight percent acrylic acid non-wetting monomer, and two weight percent ethyleneglycol diacrylate cross-linker. Additionally, 2-hydroxy-2-methylpropiophenone free-radical photoinitiator was added to the monomer formulation in an amount equal to approximately 2 weight percent of the total monomer weight. The pressure within the chamber was monitored by a sensor 84. When the chamber reached a vacuum pressure of 1.0 Torr, 0.5 ml of the formulation 88 was injected from a syringe 90, into the port 92 and the supply valve 86 was opened. The formulation supply valve 86 was closed after the formulation was injected. The formulation 88 passed into the evaporator 50, and then the formulation vapor 52 passed through a conduit 54 having a portion heated with heating tape 98. The formulation vapor then passed to the coating stage and onto the expanded fluoropolymer membrane. The first side of the expanded fluoropolymer membrane was the side facing the vaporized formulation. The mask was approximately centered on the sample leaving an open area around the perimeter of the hoop for air and additional formulation vapor to pass through, as indicated by the arrows.

The vacuum pump was then powered off and the vacuum chamber was opened. The mask was removed from the expanded fluoropolymer membrane sample. The sample was then removed from the vacuum chamber and passed through a P300, conveyor UV curing system 100, available from Fusion Systems, Gaithersburg, Md. as depicted in FIG. 6. The hoop 78 was placed on the conveyor with the first side facing the UV light source and run through at a rate of approximately 4.6 m/min.

The samples was then placed back onto the coating stage with the second side, or side opposite the first side, facing the vaporized formulation. The vacuum chamber was closed and the method of coating and curing as described in this example was repeated for the second side.

This process produced a coated expanded fluoropolymer membrane having a non-wetting monomer cross-linked with a fluoromonomer. The expanded fluoropolymer membrane made according to this example was tested according to the test method described herein and the results are reported in Table 4. The water flow time and second water flow time were 31.3 and 29 seconds respectively. The sample was hydrophobic.

### Example 6

Membrane B was coated according to the method described in Example 5, except that only the first side was coated and passed through the UV curing system. The sample was not placed back into the vacuum chamber for additional coating. The sample was tested according to the test methods described herein and data is reported in Table 4. The water flow time and second water flow time was 18 and 29 respectively. The sample was hydrophilic according to the test methods described herein. The low flow time and hydrophilic nature of the coated membrane made according to this example indicates that the coating has effectively penetrated through this relatively thick sample.

The vacuum pump was then powered off and the vacuum chamber was opened. The mask was removed from the expanded fluoropolymer membrane sample. The sample was then removed from the vacuum chamber and passed through a P300, conveyor UV curing system 100, available from Fusion Systems, Gaithersburg, Md. as depicted in FIG. 6. The hoop 78 was placed on the conveyor with the first side facing the UV light source and run through at a rate of approximately 4.6 m/min.

The samples was then placed back onto the coating stage with the second side, or side opposite the first side, facing the vaporized formulation. The vacuum chamber was closed and the method of coating and curing as described in this example was repeated for the second side.

This process produced a coated expanded fluoropolymer membrane having a non-wetting monomer cross-linked with a fluoromonomer. The expanded fluoropolymer membrane made according to this example was tested according to the test method described herein and the results are reported in Table 4. The water flow time and second water flow time were 19 and 24 seconds respectively. The sample was hydrophobic.

### Example 7

Membrane B was coated according to the method described in Example 5 except that the formulation was injected and coated onto the expanded fluoropolymer membrane sequentially. When the chamber reached a vacuum pressure of 1.0 Torr, approximately 0.1 ml of a first formulation comprising 3-perfluorohexyl-2-hydroxypropyl acrylate wetting monomer was injected from a syringe into the port and the supply valve was opened. The formulation supply valve was closed after the formulation was injected. After approximately 10 seconds, approximately 0.4 ml of a second formulation was injected. The second formulation was made by combining 98 weight percent acrylic acid non-wetting monomer, and two weight percent ethyleneglycol diacrylate cross-linker. Additionally, 2-hydroxy-2-methylpropiophenone free-radical photoinitiator was added to the monomer formulation in an amount equal to approximately 2 weight percent of the total monomer weight. The second formulation was injected from a syringe into the port and the supply valve was opened. The formulation supply valve was closed after the second formulation was injected. The sample was then inverted so that a second surface

### Comparative Example 1

Membrane B was coated according to the method described in Example 6, except that no fluoromonomer was added to the formulation. The syringe 90 was loaded with a formulation 88 containing 98 weight percent acrylic acid non-wetting monomer, and 2 weight percent ethyleneglycol diacrylate cross-linker. The coated expanded fluoropolymer membrane made according to this example had little water flow having a first and second water flow rate of 165 and 300 seconds respectively.

This demonstrates that the hydrophilic coating does not adsorb on the expanded fluoropolymer membrane as effectively when fluoromoner is not included in the coating composition.

TABLE 4

| | | Specific | | | | 2nd | |
|---|---|---|---|---|---|---|---|
| | | Surface | | Specific | Water | Water | |
| | Thickness | Area | Frazier | Resistance | Flow | Flow | |
| Membrane | um | m\hat{ }2/g | number | krayls | Seconds | Seconds | Hydrophilic |
| B | 75-100 | 4.423 | 7.2 | 3.4 | 840 | — | No |
| Example 2 | 75-100 | — | — | — | 21.4 | — | Yes |
| Example 3 | 75-100 | — | — | — | 43.3 | 51.1 | Yes |
| Example 4 | 75-100 | — | 7.1 | 3.5 | 48.4 | 46.9 | Yes |
| Example 5 | 75-100 | — | — | — | 31.3 | 29 | Yes |
| Example 6 | 75-100 | — | — | — | 18 | 29 | Yes |
| Example 7 | 75-100 | — | — | — | 19 | 24 | Yes |
| Com. Ex. 1 | 75-100 | — | — | — | 165 | 300 | Yes |

TABLE 5

| | Surface Energy |
|---|---|
| Non-wetting monomer | dyne/cm @20 C. |
| Acrylic acid | 28.5 |
| 2-carboxyethyl acrylate | 40 |
| 2-hydroxyethyl acrylate | 28 |
| Methoxy Polyethylene Glycol acrylate | 40.3 |
| Caprolactone acrylate | 42.9 |

In addition to being directed to the teachings described above and claimed below, devices and/or methods having different combinations of the features described above and claimed below are contemplated. As such, the description is also directed to other devices and/or methods having any other possible combination of the dependent features claimed below.

Numerous characteristics and advantages have been set forth in the preceding description, including various alternatives together with details of the structure and function of the devices and/or methods. The disclosure is intended as illustrative only and as such is not intended to be exhaustive. It will be evident to those skilled in the art that various modifications may be made, especially in matters of structure, materials, elements, components, shape, size and arrangement of parts including combinations within the principles of the invention, to the full extent indicated by the broad, general meaning of the terms in which the appended claims are expressed. To the extent that these various modifications do not depart from the spirit and scope of the appended claims, they are intended to be encompassed therein.

1. An article comprising:
a. an expanded fluoropolymer;
b. a coating on the expanded fluoropolymer, wherein the coating comprises a copolymer formed from the cross-linking of at least one non-wetting hydrophilic monomer with at least one fluoromonomer to form the coating on the expanded fluoropolymer.

2. The article of claim 1, wherein the expanded fluoropolymer is expanded PTFE.

3. The article of claim 1, wherein the copolymer comprises fluoroacrylate.

4. The article of claim 1 wherein the copolymer comprises perfluoroacrylate.

5. The article of claim 1, wherein the copolymer comprises perfluoroalkyl-2-hydroxypropylmethacrylate.

6. The article of claim 1, wherein the non wetting monomer comprises a hydrophilic monomer.

7. The article of claim 1, wherein the article is hydrophilic.

8. The article of claim 1, wherein the copolymer comprises a carboxylic group.

9. The article of claim 1, wherein the copolymer comprises an acrylic acid co-polymer.

10. The article of claim 1, wherein the copolymer comprises a non wetting monomer having a surface energy of at least 8 dynes/cm greater than the expanded fluoropolymer.

11. The article of claim 1, wherein the coating is a conformable coating.

12. The article of claim 3, wherein the hydrophilic monomer is copolymerized and cross-linked to a fluoroacrylate monomer.

13. The article of claim 12, wherein the hydrophilic monomer is cross-linked to the fluoromonomer with a multifunctional acrylate.

14. The article of claim 1, wherein the copolymer comprises a hydroxyl group.

15. The article of claim 1, wherein the copolymer comprises an amino group.

16. The article of claim 1, wherein the copolymer comprises a phosphonic group.

17. The article of claim 1, wherein the copolymer comprises a sulfonic group.

18. The article of claim 1 having a BET surface area greater than 10 m²/g.

19. The article of claim 1, wherein the expanded fluoropolymer is a sheet having a first surface and a second surface.

20. The article of claim 19, wherein the sheet has a thickness greater than 20 um.

21. The article of claim 20 wherein the both the first and second surfaces are hydrophilic.

22. The article of claim 1 in the form of a tube, rod, or fiber.

23. An article comprising:
a. an expanded fluoropolymer;
b. a coating on the expanded fluoropolymer,
wherein the coating comprises a copolymer formed from the evaporation, condensation and subsequent cross-linking of at least one non-wetting monomer with at least one fluoromonomer to form the coating on the expanded fluoropolymer.

24. The article of claim 23 wherein the fluoromonomer and non-wetting monomer are evaporated and condensed simultaneously.

25. The article of claim 23 wherein the article is hydrophilic.

26. The article of claim 23 wherein non-wetting monomer is cross-linked to the perfluoroacrylate monomer by exposure to a high energy source.

27. The article of claim 26 wherein the high energy source comprises ultraviolet light.

28. The article of claim 23 wherein a cross-linking monomer is evaporated and condensed onto the expanded fluoropolymer.

29. The article of claim 23 wherein the non-wetting monomer is cross-linked to the fluoromonomer.

30. The article of claim 23 wherein a cross-linking monomer, fluoromonomer and non-wetting monomer are evaporated and condensed simultaneously.

31. The article of claim 30 wherein the cross-linking monomer is a multifunctional acrylate.

32. The article of claim 23 wherein the coating is a conformable coating.

32. The article of claim 23 in the form of a tube, rod, or fiber.

33. The article of claim 23, wherein the copolymer comprises a hydroxyl group.

34. The article of claim 23, wherein the copolymer comprises an amino group.

35. The article of claim 23, wherein the copolymer comprises a phosphonic group.

36. The article of claim 23, wherein the copolymer comprises a sulfonic group.

37. The article of claim 23, wherein the copolymer comprises a carboxylic group.

38. The article of claim 23, wherein the copolymer comprises an acrylic acid co-polymer.
